(19) United States
(12) Patent Application Publication
(10) Pub. No.: US 2007/0226206 A1
(43) Pub. Date: Sep. 27, 2007

(54) Consecutive crawling to identify transient links

(76) Inventors: Dmitri Pavlovski, San Francisco, CA (US); Vladimir Ofitserov, Foster City, CA (US); Alexander Arsky, Los Altos, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/388,681

(22) Filed: Mar. 23, 2006

(51) Int. Cl. G06F 17/30

(52) U.S. Cl. 707/5

(57) ABSTRACT

According to the approach described herein, an approach is provided for identifying transient links on a Web page by crawling a Web page consecutively after a brief interval and comparing the links from each crawl to identify transient links. The approach ensures that transient links are not crawled and archived, thereby saving resources for crawling valid links leading to useful information

### FIELD OF THE INVENTION

This invention relates generally to Web crawling, and more specifically, to techniques for identifying transient links.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

The most widely used part of the Internet is the World Wide Web, often abbreviated “WWW” or simply referred to as just “the Web”. The Web is an Internet service that organizes information through the use of hypermedia. The HyperText Markup Language (“HTML”) is typically used to specify the content and format of a hypermedia document (e.g., a Web page).

Each Web page can contain embedded references, referred to as “links”, to images, audio, video or other Web pages. The most common type of link used to identify and locate resources on the Internet is the Uniform Resource Locator, or URL. In the context of the Web, a user, using a Web browser, browses for information by selecting links that are embedded in each Web page.

Because the Web provides access to billions of pages of information that are often poorly organized, it can be difficult for users to locate particular Web pages that contain the information that is of interest to them. To address this problem, a mechanism known as a “search engine” has been developed to index a large number of Web pages and to provide an interface that can be used to search the indexed information by entering certain words or phrases (keywords) to be queried.

Although there are many popular Internet search engines, they all generally include a “Web crawler” (also referred to as “crawler”, “spider”, and “robot”) that “crawls” across the Internet in a methodical and automated manner to locate Web pages around the world. Upon locating a document, the crawler stores the document and the document's URL, and follows any hyperlinks associated with the document to locate other Web pages. Feature extraction engines then process the crawled and locally stored documents to extract structured information from the documents. In response to a search query, some structured information that satisfies the query (or documents that contain the information that satisfies the query) is usually displayed to the user along with a link pointing to the source of that information. For example, search results typically display a small portion of the page content and have a link pointing to the original page containing that information.

Web crawlers use a wide variety of crawl algorithms to determine the order in which Web pages are crawled. For example, a first-in-first-out by link approach may be used. With this approach, links are crawled based upon the order in which they are located on a Web page. As another example, a “best first” approach may be used where the order in which links are to be crawled is selected based upon link relevancy, i.e., the links considered to be the more relevant are crawled before links that are considered to be less relevant.

The growing use of advertising on the Web has spurred the use of URLs for user identification, user tracking, and other purposes. For example, a Web page with useful information may contain an advertisement that comprises an image and a link embedded within the image to a page with information about the advertised product. The link may contain information allowing the advertiser to track the number of unique visitors to its Web site emanating from the advertisement, as well as other information. This information may take the form of a Session ID, Tracking URL, or other technique. The information may be unique. These links are rarely useful for crawling or inclusion into a searchable index. Moreover, the pages linked by these URLs frequently contain duplicated information or are disallowed for crawling.

If a user refreshes the page containing the advertisement, then another advertisement may appear with a different link, or the same advertisement linking to the same page may appear with a new unique identifier. The different link may contain a new unique identifier. Therefore, after the page refresh, every outgoing link on the page may be the same except for the new advertisement URL. The links that change are transient in nature. This technique results in an infinite number of URLs linking to the same destination.

Because the purpose of a Web crawler is to discover pages that contain useful information for web users, it would be inefficient and wasteful of resources to crawl and index every transient link whose only significance is being used as a unique tracking or session identifier.

The common approach to Web crawling is to extract all outgoing links on a page and follow them while archiving the content of the pages. This is inefficient, as stated earlier, because there is no need to follow transient links that lead to non-useful information. These links often lead to pages with duplicated information or are disallowed for crawling. This leads to inefficient use of crawling resources and discovery of a large number of low-quality content.

An approach to avoiding the problems caused by transient links, such as advertisement and tracking URLs, during the Web crawling process is to employ sophisticated programs that render content on the page in the way similar to the Web browser in order to reproduce layout of the page. Then heuristics or machine learned algorithms are used to try to identify part of the page that contains advertisement or tracking links in order to avoid following them. This approach is ineffective because it is overly complex, may be subject to errors and requires constant tuning as new ways of presenting information on the Web appear.

Based on the foregoing, there is a need for improved techniques for detecting transient links, and detecting them in an efficient and timely manner prior to expending resources to crawl and archive the pages linked.

### BRIEF DESCRIPTION OF THE DRAWINGS

In the figures of the accompanying drawings like reference numerals refer to similar elements.

FIG. 1 is a block diagram that depicts an arrangement for requesting Web pages from a Web server according to an embodiment of the invention.

FIG. 2 is a block diagram that depicts an example Web page 200 to be crawled according to an embodiment of the invention.

FIG. 3 is a flow diagram illustrating an approach for identifying transient links, according to an embodiment of the invention.

FIG. 4 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:

I. OVERVIEW

II. ARCHITECTURE

III. IDENTIFYING TRANSIENT LINKS

IV. IMPLEMENTATION MECHANISMS

I. Overview

An approach is provided for identifying transient links on a Web page. The approach ensures that transient links are not crawled and archived, thereby saving resources for crawling valid links leading to useful information. Outgoing links on a web page are identified, and after a period of time, a new copy of the web page is obtained and the outgoing links identified. The respective sets of links are compared and links which do not appear in both sets of links are identified as transient.

II. Architecture

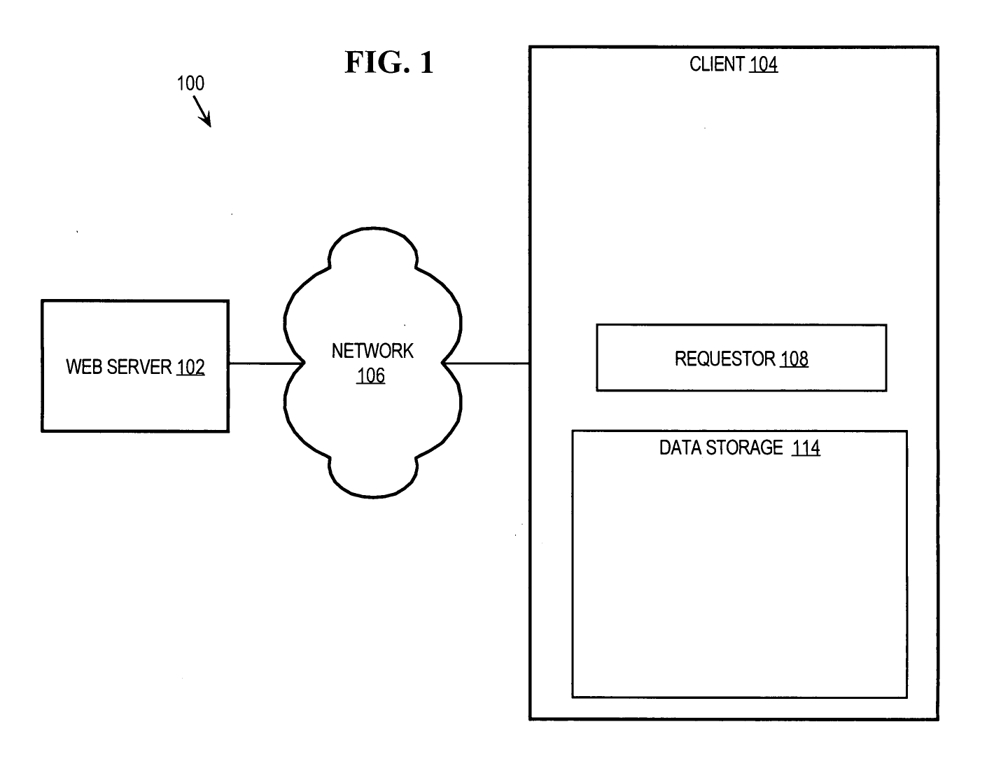

FIG. 1 is a block diagram that depicts a system 100 for requesting Web pages from a Web server as part of the crawling process, according to an embodiment of the invention. Arrangement 100 includes a Web server 102 communicatively coupled to a client 104 via a network 106. Network 106 may be implemented by any medium or mechanism that provides for the exchange of data between Web server 102 and client 104. Examples of network 106 include, without limitation, one or more Local Area Networks (LANs), Wide Area Networks (WANs), Ethernets or the Internet, or one or more terrestrial, satellite or wireless links. Web server 102 and client 104 are depicted in FIG. 1 as being disposed external to network 106 for purposes of explanation only. Web server 102 and client 104 may also be disposed within network 106, depending upon a particular implementation.

Web server 102 may be implemented by any mechanism or process that is configured to process requests for Web pages and provide Web pages in response to processing those requests. Web server 102 may include a wide variety of components and processes that are not depicted in FIG. 1 and described herein. The approach described herein for requesting Web pages from a Web server is not limited to any particular type of Web server or Web server configuration. For example, Web server 102 may include a non-volatile storage, such as one or more disks, and a process for processing requests for Web pages and causing Web pages to be generated and provided to the requester. One example implementation of Web server 102 is an Apache Web server.

Client 104 may be implemented by any mechanism or process configured to request Web pages from Web server 102. One example implementation of client 104 is a Web crawler, although the approach described herein is not limited to this context. According to one embodiment of the invention, client 104 is configured with a requestor 108 and data storage 114. Client 104 may be configured with additional elements and processes. The elements and functionality of client 104 depicted in FIG. 1 and described herein are not all required. Thus, the particular elements and functionality of client 104 may vary, depending upon a particular implementation.

Requestor 108 is a mechanism or process configured to generate requests for Web pages. Requestor 108 may receive input from a user of client 104. According to an embodiment, the input may be manually specified by users through conventional web browsers. According to another embodiment, the input is specified as part of automated crawling techniques.

Data storage 114 may be implemented by any type of storage, volatile, non-volatile or any combination of volatile and non-volatile storage. Examples of data storage include, without limitation, Random Access Memory (RAM), optical storage, magneto-optical storage, tape and one or more disks.

III. Identifying Transient Links

### Identifying Transient Links Based On Multiple Crawls of the Same Page

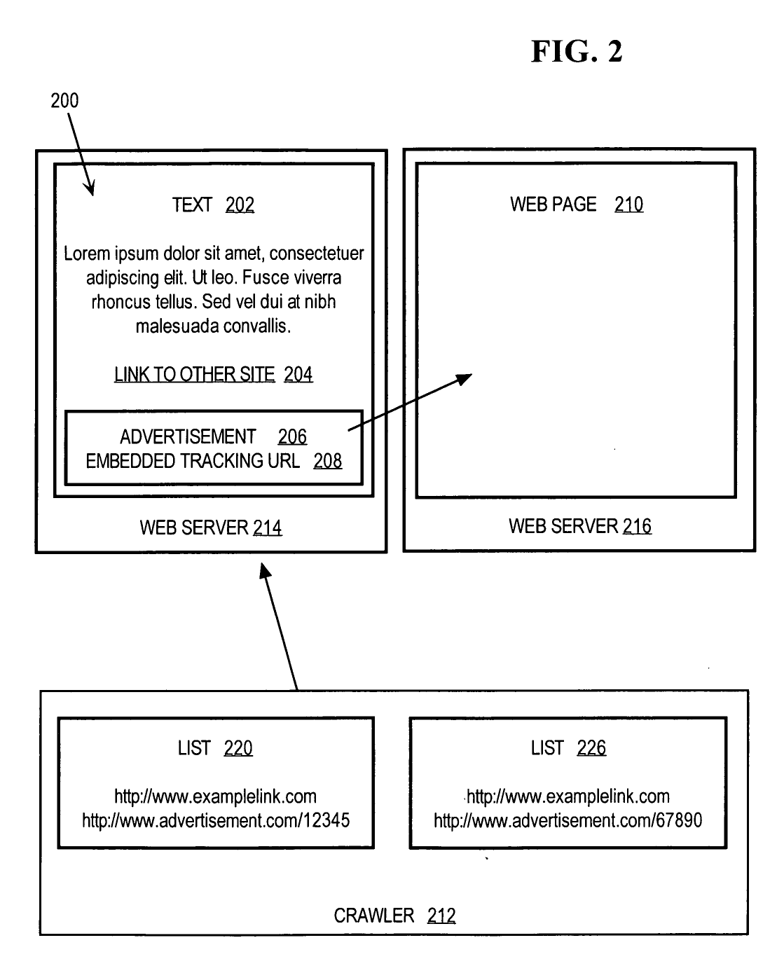

FIG. 2 is a block diagram that depicts an example Web page 200 on Web server 214. Reference will be made to Web page 200 in describing how web pages may be crawled according to the techniques described herein.

Web page 200 includes text 202, a link 204 to another page and an advertisement 206. The link 204 comprises a URL to a page with useful information to be crawled and archived. The advertisement 206 is an image with an embedded tracking URL 208. When the web crawler follows the tracking URL 208 of the advertisement 206, the crawler is directed to Web page 210, perhaps located on a different Web server 216.

In accordance with the techniques described herein, a crawler 212 generates a request for Web page 200 that specifies the URL of the Web page 200. The request is sent from the web crawler to a Web server 214 that hosts Web page 200. The Web server 214 processes the request and provides, to the crawler 212, HTML describing the Web page 200. The crawler 212 receives the HTML describing the Web page 200 and extracts all URLs from the Web page 200. This results in a list of the extracted URLs being stored, for example in list 220. After a period of time, the crawler 212 issues a refresh command for a new copy of the same Web page 200. While one minute has been found to give the best results, any length of time may be used.

Web server 214 processes the refresh request and provides to the crawler 212 another copy of HTML describing Web page 200. As part of this process, the Web server 214 inserts into the new copy of the web page a new advertisement with a new embedded tracking URL in place of the old advertisement 206. The crawler 212 downloads the HTML describing the new copy of the Web page 200 and extracts all URLs from the refreshed Web page 200. This results in a list of the newly extracted URLs being stored, for example in list 226.

The crawler 212 compares the originally extracted URLs with the newly extracted URLs. URLs contained in the first crawl of the Web page that have disappeared in the subsequent crawl of the Web page are transient, and not useful for crawling or inclusion into a searchable index. In one embodiment, all links that appear in both of the consecutive crawls of the same page are marked as suitable for crawling and inclusion in an index, and are indeed crawled. According to an embodiment, any number of links from a Web page may be extracted and compared using the techniques described herein.

According to an embodiment, the URLs are compared by taking the strings that comprise each URL identified on the first crawl and comparing those strings to the list of URLs identified on the second crawl. Once a URL from the first crawl is matched with a URL from the second crawl, it is crawled in accordance with crawling techniques. Transient links identified by comparing the URLs identified from the consecutive crawls and identifying URLs that did not exist in both crawls as transient are not crawled.

According to further embodiments of the invention, there exist further techniques for comparing the URLs. According to an embodiment, an original URL string is transformed into an identifier (ID). The transformation may be done using string transformations (e.g. lowercasing) or normalization (e.g. %-escaping) and also including any kind of numeric hashing function such as CRC, checksum or MD5. In fact, calculation and storing of numeric ID of the URL instead of the original URL after first crawl of the page allows reducing storage requirement in the implementation. Replacing the original URL with the numeric ID does not significantly impact the outcome of the identification of transient links.

### Steps for Identifying Transient Links Based On Multiple Crawls of the Same Page

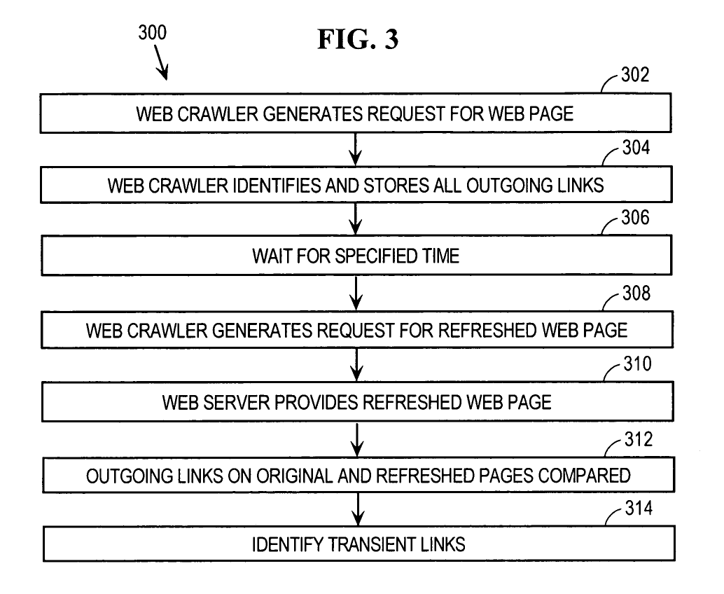

FIG. 3 is a flow diagram 300 illustrating an approach for identifying transient links, according to an embodiment of the invention. In step 302, the crawler generates a request for a Web page. In step 302, a Web server processes the request and provides a Web page. In step 304, the crawler identifies and stores all outgoing links on the Web page. In step 306, the crawler waits a specified amount of time. During the waiting period, the crawler does not attempt to crawl or index the outgoing links extracted from the Web page.

In step 308, after the waiting period has ended, the crawler generates a request for a refreshed version of the same Web page. In step 310, the Web server processes the request and provides a new copy of the Web page. In step 312, the crawler compares the outgoing links discovered in the first crawl operation with the outgoing links discovered in the second crawl operation. In step 314, links that have disappeared after the consecutive crawls are identified as transient and not useful for crawling or inclusion into a searchable index.

### Identifying Transient Links Using Fewer Crawls of the Same Page

According to an embodiment, additional methods of identifying transient links may be used instead of, or in combination with, the technique of comparing the results of consecutive crawls of the same document. For example, one method of identifying transient links involves identifying portions of the Web page HTML that produce the transient links identified by the techniques described herein and ignoring links generated by identical portions of HTML in subsequent crawls performed against the same page in the future

One approach for the identification of portions of HTML can be performed using Document Object Model Tree (DOM) decomposition. A DOM tree is a representation of a portion of HTML using a tree of HTML tags where group tags like <table> have sub-tree tags <tr> and in turn <tr> tags have leaf tags <td>. In general, a DOM tree contains tags and their text and attributes. To identify transient links using fewer crawls of the page, the crawler can initially fetch a page several times, decompose the HTML comprising the page into a DOM tree, identify transient links and identify transient DOM sub-tree elements that contain only transient links. When crawling the same page in the future, if the crawler discovers that page has a DOM tree identical to previously crawled instances, then the crawler may consider the new links originating from the same transient DOM sub-tree as transient without additional fetches of same page.

According to an embodiment, since many websites share the same template, an identified transient DOM sub-tree from the test page may be used to identify transient links on other pages of the same website. After the crawler performed the steps as described above, it can compare the DOM tree of other pages from the website with the DOM tree of the test page. If DOM trees of other pages include previously identified transient DOM sub-trees, then the crawler can ignore new links from the transient DOM sub-tree of the page.

According to an embodiment, to reduce the number of consecutive fetches, a crawler can attempt to identify websites that are frequently used as targets of transient links. An approach that can be used involves identification of transient links by using the techniques described above, and further aggregating all links by target websites and identifying websites for which most of the links are transient. The crawler may later use a list of such websites to identify all future links to them as transient links without performing additional fetches of the same page.

V. Implementation Mechanisms

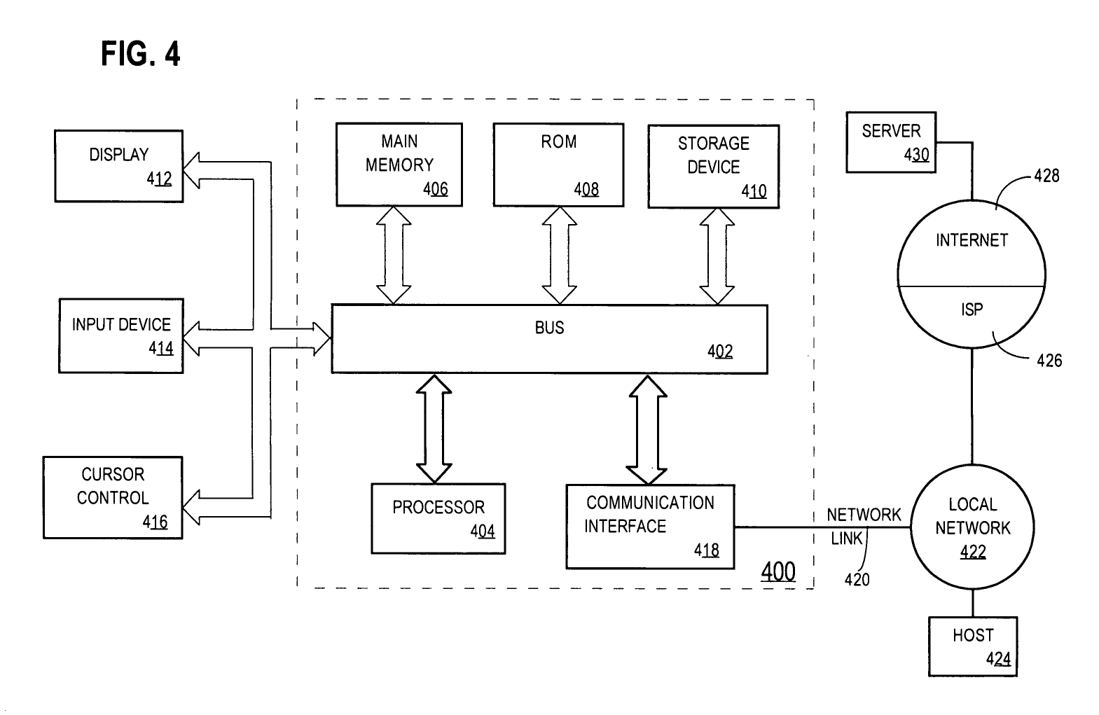

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for identifying transient links, the computer-implemented method comprising:
obtaining a first copy of a Web page;
identifying a first plurality of outgoing links from the first copy of Web page;
after a period of time has passed since obtaining the first copy of the Web page,
obtaining a second copy of the Web page;
identifying a second plurality of outgoing links from the second copy of the Web page;
determining which outgoing links in said Web page are transient based on a comparison between the first plurality of outgoing links and the second plurality of outgoing links.

2. The computer-implemented method as recited in claim 1, further comprising marking all outgoing links that are included in both the first and second pluralities as suitable for crawling.

3. The computer-implemented method as recited in claim 1, further comprising:
obtaining the first copy by making a first request for a Web page from a Web server;
and
obtaining the second copy by making a second request for the Web page from the Web server;

4. The computer-implemented method as recited in claim 1, further comprising marking all outgoing links that are contained in both the first plurality and the second plurality as suitable for inclusion into an index.

5. The computer-implemented method as recited in claim 1, wherein the period of time is one minute.

6. The computer-implemented method as recited in claim 1, further comprising not crawling the outgoing links until completion of the comparison.

7. The computer-implemented method as recited in claim 1, further comprising identifying all links that changed between obtaining the first and second copies as transient and unsuitable for crawling.

8. The computer-implemented method as recited in claim 1, wherein the method of comparison used to compare the links comprises a string comparison.

9. The computer-implemented method as recited in claim 1, further comprising transforming the links into identifiers.

10. The computer-implemented method as recited in claim 1, wherein all outgoing links on the Web page are identified and compared.

11. The computer-implemented method as recited in claim 1, further comprising crawling all outgoing links that remained static between obtaining the first and second copies.

12. The computer-implemented method as recited in claim 1, further comprising:
identifying portions of the Web page that produce transient links; and
ignoring links generated by the portions while obtaining subsequent copies of the Web page.

13. The computer-implemented method as recited in claim 11, further comprising:
ignoring links generated by the portions in subsequent requests for all Web pages from a particular domain.

14. The computer-implemented method as recited in claim 1, further comprising:
maintaining data pertaining to links that are likely to be transient, wherein the data comprises a DOM sub-tree; and
based on the data, identifying links on a Web page as transient and unsuitable for crawling.

15. A computer-readable medium for identifying transient links, the computer-readable medium carrying instructions which, when processed by one or more processors, causes the one or more processors to perform the method of:
obtaining a first copy of a Web page;
identifying a first plurality of outgoing links from the first copy of Web page;
after a period of time has passed since obtaining the first copy of the Web page,
obtaining a second copy of the Web page;
identifying a second plurality of outgoing links from the second copy of the Web page;
determining which outgoing links in said Web page are transient based on a comparison between the first plurality of outgoing links and the second plurality of outgoing links.

16. A computer-readable medium for identifying transient links, the computer-readable medium carrying instructions which, when processed by one or more processors, causes the one or more processors to perform the method recited in claim 2.

17. A computer-readable medium for identifying transient links, the computer-readable medium carrying instructions which, when processed by one or more processors, causes the one or more processors to perform the method recited in claim 3.

18. A computer-readable medium for identifying transient links, the computer-readable medium carrying instructions which, when processed by one or more processors, causes the one or more processors to perform the method recited in claim 4.

19. A computer-readable medium for identifying transient links, the computer-readable medium carrying instructions which, when processed by one or more processors, causes the one or more processors to perform the method recited in claim 5.

20. A computer-readable medium for identifying transient links, the computer-readable medium carrying instructions which, when processed by one or more processors, causes the one or more processors to perform the method recited in claim 6.

21. A computer-readable medium for identifying transient links, the computer-readable medium carrying instructions which, when processed by one or more processors, causes the one or more processors to perform the method recited in claim 7.

22. A computer-readable medium for identifying transient links, the computer-readable medium carrying instructions which, when processed by one or more processors, causes the one or more processors to perform the method recited in claim 8.

23. A computer-readable medium for identifying transient links, the computer-readable medium carrying instructions which, when processed by one or more processors, causes the one or more processors to perform the method recited in claim 9.

24. A computer-readable medium for identifying transient links, the computer-readable medium carrying instructions which, when processed by one or more processors, causes the one or more processors to perform the method recited in claim 10.

25. A computer-readable medium for identifying transient links, the computer-readable medium carrying instructions which, when processed by one or more processors, causes the one or more processors to perform the method recited in claim 11.

26. A computer-readable medium for identifying transient links, the computer-readable medium carrying instructions which, when processed by one or more processors, causes the one or more processors to perform the method recited in claim 12.

27. A computer-readable medium for identifying transient links, the computer-readable medium carrying instructions which, when processed by one or more processors, causes the one or more processors to perform the method recited in claim 13.

28. A computer-readable medium for identifying transient links, the computer-readable medium carrying instructions which, when processed by one or more processors, causes the one or more processors to perform the method recited in claim 14.

29. A computer-implemented method for identifying transient links, the computer-implemented method comprising:
making a first request for a Web page from a Web server;
identifying and storing a plurality of outgoing links on the Web page;
after a period of time, making a second request for the Web page from the Web server;
identifying and storing a plurality of outgoing links on the Web page;
comparing at least one outgoing link identified during the second request to the
outgoing link as identified during the first request; and
based on the comparison, identifying links that changed between the first and second requests as transient and unsuitable for crawling.

30. A computer-readable medium for identifying transient links, the computer-readable medium carrying instructions which, when processed by one or more processors, causes the one or more processors to perform the method recited in claim 29.
